(19) United States
(12) Patent Application Publication
(10) Pub. No.: US 2026/0258273 A1
(43) Pub. Date: Sep. 3, 2026

(54) METHOD FOR PRODUCING A CURING AGENT FOR A WATERBORNE EPOXY COATING FORMULATION

(71) Applicant: SPECIALTY OPERATIONS FRANCE, Lyon (FR)

(72) Inventors: Steven Meeker, Gazinet-Cestas (FR); Sergio Mastroianni, Lyon (FR); Jean-Christophe Castaing, Sèvres (FR); Rong Er Lin, Singapore (SG)

(73) Assignee: SPECIALTY OPERATIONS FRANCE, Lyon (FR)

(21) Appl. No.: 18/878,556

(22) PCT Filed: Jun. 19, 2023
(86) PCT No.: PCT/EP2023/066456

§ 371 Date: Dec. 23, 2024

(30) Foreign Application Priority Data
Jun. 24, 2022 (EP) 22305920.5

(51) Int. Cl. C09D 163/00; B05D 3/02; C08G 59/18; C08G 59/54; C09D 7/20

(52) U.S. Cl. CPC C09D 163/00; B05D 3/0272; C08G 59/184; C08G 59/54; C09D 7/20

(57) ABSTRACT

The present invention concerns a method for producing a curing agent for a waterborne epoxy coating formulation, said method comprising a step of carbonating a waterborne dispersion of a water insoluble curing agent comprising amine and/or amide functional groups, and the use of said curing agent for applying a waterborne epoxy coating on a substrate.

### TECHNICAL FIELD OF THE INVENTION

This application claims priority to application Nr 22305920.5 filed on 24 Jun. 2022 in Europe, the whole content of which is incorporated herein by reference for all purposes.

The present invention concerns a method for producing a curing agent for a waterborne epoxy coating formulation and the use of said curing agent for applying a waterborne epoxy coating on a substrate.

### TECHNICAL BACKGROUND

Epoxy resins as basis for coatings were commercialised many years ago. Historically, most high-performance epoxy coatings were based on solvent-based formulations. Although they provide excellent performance, they have the disadvantage of relatively high VOC (Volatile Organic Compounds) content. Hence, waterborne epoxy coating formulations with significantly lower VOC levels than solvent-based epoxy coating formulations have been developed.

These generally use compounds containing a plurality of amine groups to cure the epoxy resin. However, coating formulations obtained by mixing epoxy resin(s) and amine group containing compound(s) are generally not stable and should be applied as soon as possible on a substrate to be able to form a single continuous phase. They have hence a so-called limited pot life.

U.S. Pat. No. 4,526,721 solves that problem by providing a method of producing a curing agent for an epoxy resin which comprises the steps of dissolving in water an amidoamine or an imidazoline and by contacting the so obtained solution with carbon dioxide. This method is specific to water-soluble amine curing agents.

However, the latest generation of waterborne epoxy formulations is based on hydrophobic, water insoluble amine or amide curing agents. Such formulations namely provide a coating with improved chemical resistance and corrosion protection compared to formulations comprising a hydrophilic water soluble amine curing agent. The Applicant found out that carbonating a dispersion of a water insoluble amine or amide also enables providing a curing agent for a waterborne epoxy coating formulation with improved pot life. Besides, provided the obtained coating is properly cured, it presents high chemical resistance and corrosion protection properties.

### BRIEF DESCRIPTION OF THE INVENTION

Therefore, a first object of the present invention is a method for producing a waterborne curing agent for a waterborne epoxy coating formulation, said method comprising a step of carbonating a waterborne dispersion of a water insoluble curing agent comprising amine and/or amide functional groups.

For a two-component epoxy coating system, the epoxy resin, often called the part A, is mixed with the curing agent, often called the part B or hardener. The curing agent reacts chemically with the epoxy resin to give a high performance coating with excellent mechanical and chemical resistance.

For a waterborne epoxy coating system, the curing agent may be soluble or insoluble in water. A water-soluble curing agent is completely miscible with water, forming a homogeneous mixture. It is composed of one phase.

A water insoluble curing agent is a mixture of curing agent in water that is not homogeneous, such as colloidal suspensions and emulsions. They comprise at least two phases. Non-limiting examples are (i) a colloidal suspension comprising solid particles of curing agent dispersed in water; (ii) liquid droplets of curing agent dispersed in water, where the liquid curing agent is immiscible with the surrounding aqueous phase. The typical (non-limiting) size range of the colloidal particles/liquid droplets is from about 50 nm to 5 about μm.

In the frame of the invention, waterborne epoxy formulations comprise an aqueous continuous phase and a solid dispersed phase. The aqueous phase may comprise besides water, solvent(s) and/or dissolved curing agent. The dispersed phase comprises epoxy resin articles and may comprise curing agent particles. The solvent(s) are generally chosen among acetone and glycol ethers, more particularly ethylene and propylene glycol ethers. Waterborne epoxy formulations may comprise other ingredients like pigments, defoamers . . . .

The waterborne epoxy formulation of the invention is obtained by mixing a waterborne epoxy dispersion with a waterborne curing agent dispersion or solution, and eventually with a solvent as mentioned above. An advantage of the invention is an increased pot life of the formulation once the two components are mixed when compared to a formulation also based on an insoluble amine curing agent dispersion but which has not been pre-treated by carbonation.

### BRIEF DESCRIPTION OF THE DRAWINGS

Further features and advantages of the invention will become apparent from the detailed description to follow, with reference to the appended drawings, in which:

FIG. 1 is a graph representing the evolution of the Brookfield viscosity of waterborne epoxy coating formulations, with and without CO2 treatment, as a function of pot life;

FIG. 2 is a graph representing the evolution of gloss of dry coatings, which were applied on varnished opacity cards, as a function of pot life.

### DETAILED DESCRIPTION OF EMBODIMENTS OF THE INVENTION

The waterborne epoxy dispersion comprises epoxy resin particles, water and eventually a solvent as described above, but in an amount of no more than 10% in weight, preferably no more than 5%. The amount of epoxy particles is generally between 50 and 60% in weight in the dispersion. The epoxy resin is generally of the bisphenol A type, but other epoxy resins may be used as well (for instance bisphenol F or Novolac resins). The epoxy resin may comprise a build-in surfactant or emulsifier. Alternatively or additionally, the waterborne epoxy dispersion may comprise a surfactant or emulsifier. Such waterborne epoxy dispersions are commercially available, and one that gives good results in the frame of the present invention is sold under the brand name EPIKOTE™ Resin 6520-WH-53. These commercial dispersions may be used as such or diluted with water and/or solvent prior to use.

The waterborne dispersion of the water insoluble curing agent comprises curing agent particles dispersed in a liquid phase comprising water and eventually a solvent as described above, but in an amount of no more than 10% in weight, preferably no more than 5%.

The curing agent used in the present invention is a chemical compound comprising amine and/or amide functions that are able to react with the epoxide functions of the epoxy resin. It may be a polyamide, a polyamidoamine or a polyamine. Polyamines are preferred especially if chemical and stain resistance and anti-corrosion protection are key properties for the final coating. More preferably, polyamines having an amine value from 100 to 350 are used. The amine value is measured by titrating a known mass of polyamine against hydrochloric acid, and is expressed as mg KOH/g.

Preferred polyamines are those comprising of a modified polyamine adduct, preferably comprising aliphatic polyamine moieties, more preferably comprising primary and/or secondary unhindered amine groups, like triethylenetetramine or N,N′-bis(3-aminopropyl)ethylenediamine moieties. In a preferred embodiment, the aliphatic polyamine moieties are reacted with bisphenol A diglycidyl ether in order to increase epoxy compatibility. In still a further preferred embodiment, the amine functions can be reacted with EO/PO and/or with fatty acids to make the polyamine water dispersible.

According to the invention, prior to its carbonation, the curing agent is water insoluble at least at room temperature. In a preferred embodiment, the curing agent becomes at least partly water-soluble (and hence, becomes less opaque) at room temperature after carbonation. This has the advantage of improving the compatibility with waterborne epoxy resin and enhancing the film properties of the coating after curing.

As is the case for the epoxy resin, the curing agent may comprise a built-in surfactant (or emulsifier). Alternatively or additionally, the waterborne dispersion of the curing agent may comprise a surfactant in its liquid phase.

The waterborne curing agent dispersion contains solid particles of the curing agent dispersed in an aqueous phase, generally in an amount between 50 and 60% in weight of particles in the aqueous dispersion. It may contain a solvent as described above, for instance an ethylene glycol ether or a propylene glycol ether, generally in an amount of at most 10% in weight.

Waterborne curing agent dispersions as described above are commercially available, for instance those sold under the brand name EPIKURE™ 6870-W-53 (amine value of 250) or BECKOPOX® VEH 2188w/55WA (amine value of 135). These may be used as such or diluted with water and/or solvent prior to use.

The step of carbonating is conducted by contacting the waterborne curing agent dispersion with liquid, solid or gaseous carbon dioxide, the latter being preferred. It can be conducted within a large range of temperatures, for instance from 0-100° C., preferably between 10 and 40° C., more preferably at room temperature. It can be conducted within a large range of pressures, but is preferably conducted at atmospheric pressure, more preferably by bubbling CO2 gas in the curing agent dispersion at room temperature.

Generally, the duration of carbonation is such as to block a significant amount of the amine/amide groups of the curing agent. The evolution of the pH is generally a good indication of this. Hence, it might be advantageous to measure the pH at the beginning and at the end of the carbonation step, and preferably to monitor it during the whole carbonation step. In a preferred embodiment, the carbonating step is ended when the pH of the dispersion is stable and close to a target value which is preferably such that the pot life is long enough and the film properties equivalent as without carbonation. The present invention also concerns the use of the waterborne curing agent obtained as described above, in a waterborne epoxy coating formulation. More specifically, a second object of the present invention is a process for providing a substrate with a waterborne epoxy coating, said process comprising the steps of:
producing a carbonated waterborne curing agent as described above;
mixing said waterborne curing agent with a waterborne epoxy dispersion to obtain a waterborne epoxy coating formulation (the mixing step);
applying said waterborne epoxy coating formulation on a substrate (the application step);
curing the waterborne epoxy coating formulation on the substrate (the curing step).

The waterborne epoxy dispersion and waterborne epoxy formulation of the invention are as described above.

In a preferred embodiment, the waterborne epoxy formulation comprises a solvent chosen among acetone and glycol ethers, more particularly ethylene and propylene glycol ethers. This solvent can be introduced as a separate ingredient during the mixing step and/or can be added via the waterborne curing agent and/or via the waterborne epoxy dispersion.

Any substrate may be used in the process of the invention. However, their nature might be conditioned by the temperature used for the curing step. Hence, metal, glass, enamel . . . substrates give good results in the frame of the invention.

In a preferred embodiment of the invention, the waterborne curing agent is made substantially free of CO2 gas bubbles prior to its use in the mixing step. This can for instance be achieved by ageing the carbonated curing agent in conditions where the excess CO2 (non-reacted with the amine) can leave the system.

In the mixing step, the amount of waterborne curing agent vs the amount of waterborne epoxy dispersion is adapted to a target stoichiometric ratio between the amine/amide hydrogen and the epoxy functions. In practice, this is calculated using the equivalent weights of the epoxy resin and the amine/amide hydrogen equivalent weight of the curing agent. The epoxy equivalent weight (EEW) is defined as the number of grams of epoxy resin required to give 1 mole of epoxy groups. The amine/amide hydrogen equivalent weight (AHEW) of the curing agent is the number of grams of the curing agent required to give 1 mole of amine/amide hydrogen.

In the process of the invention, the duration between the mixing step and the application step can be extended up to 24 hours (compared to only a few hours in the prior art) without impairing the coating ability and quality. More precisely: the mixture still remains applicable after this time (that is, it remains sufficiently fluid) and coatings made from the mixture still have good visual appearance, such as film gloss, and good mechanical and chemical resistance provided they are properly cured. In other words: the invention allows to have the benefit of a two-pack coating system of significantly extended pot life, without having to compromise on the final mechanical properties and chemical resistance of the coatings.

The method of applying the coating formulation on the surface is not critical. It may be by using brush and/or roll, spray coating etc., preferably on a pre-treated surface free of oil, grease, dirt, previous paint etc.

On the other hand, the curing step is a key element of the process of the invention. It namely has the purpose of unblocking the amine/amide functions of the curing agent so that they can react with the epoxide functions of the epoxy resin and form the coating. For some formulations and/or depending on the properties required for the final coating, room temperature curing can be sufficient. However, in order to obtain a chemically resistant coating, the temperature during this step is preferably of at least 50° C., preferably of at least 60° C. Depending on the chemical nature of the curing agent, temperatures up to 95° C. may be required, and even up to 120° C. However, especially when the curing agent becomes at least partially water-soluble after carbonation, a temperature between 5° and 90° C., preferably between 60 and 80° C., might be sufficient. The duration of the curing step should be adapted in order for the cure to be substantial i.e. to provide a coating with the required mechanical and chemical resistance. This generally requires less than one hour.

In a preferred embodiment of the invention, a curing at a temperature above room temperature is performed while said coating is still wet. This eases the unblocking of the amine/amide functions and allows speeding up the process and/or lowering the curing temperature which is valuable from an industrial point of view.

The present invention is illustrated by the Examples below, which relate to some preferred embodiments thereof.

### EXAMPLES

### Example 1

The materials detailed in Table 1 below were used to make the waterborne epoxy coating formulation detailed in Table 2 below.

TABLE 1

| Reference | Material | Description |
|---|---|---|
| EPIREZ-1 | EPIKOTE™ | 53% solids. non-ionic aqueous |
| | Resin 6520- | dispersion of a modified EPON™ |
| | WH-53 | Resin 1001 type solid epoxy |
| | | resin (EEW = 550) |
| EPIKURE-1 | EPIKURE™ | 53% solids. non-ionic aqueous |
| | Curing Agent | dispersion of a modified |
| | 6870-W-53 | polyamine adduct curing agent |
| | | (AHEW = 225) |
| DPnB | DOWANOL™ | Dipropylene glycol n-butyl ether. |
| | DPnB | |

TABLE 2
Waterborne (WB) Epoxy Coating Formulation 1

| Reference | Mass (g) |
|---|---|
| Part A | |
| EPIKOTE™ Resin 6520-WH-53 | 59.8 |
| DOWANOL™ DPnB | 3.7 |
| water | 12.0 |
| Total A | 75.5 |
| Part B | |
| EPIKURE™ 6870-WH-53 | 24.5 |
| Total B | 24.5 |
| Total A & B | 100.0 |

For the part A, the solvent (DPnB) was added to the resin and left to stir over 2 days, to ensure a good partitioning between the solvent and the epoxy particles comprising the resin.

For the pot life test, the part B was added to the part A and stirred vigorously with a spatula to assure homogenization, the whole formulation being contained in a beaker. To monitor pot life performance, two types of measurements were performed at regular intervals (typically 1 hour):
Brookfield viscosity measurement of the mixed coating formulation. The Brookfield spindle (RV04) was immersed into the formulation and the (apparent) viscosity measured at a spindle rotation rate of 10 rpm.
Wet film application. Wet films of the WB epoxy coating formulations were applied to various substrates (see below) and left to dry and cure at ambient temperature.

### Example 2

The weights of each material to be used in the WB epoxy coating are the same as in Example 1, with the hardener in part B being replaced with the hardener treated with CO2 as described below.

Treatment of Hardener (Part B) with Carbon Dioxide

A mass of 50 g of Epikure (hardener) was measured into a beaker. The pH was measured and determined to be 10.7 (at 21.7° C.). The hardener was CO2 sparged via a gas dispersion tube connected to a CO2 cylinder, for a duration of 25 minutes. The pH was re-measured, and determined to be 7.1, suggesting that a significant reaction between the amines and the CO2 had taken place.

### Results

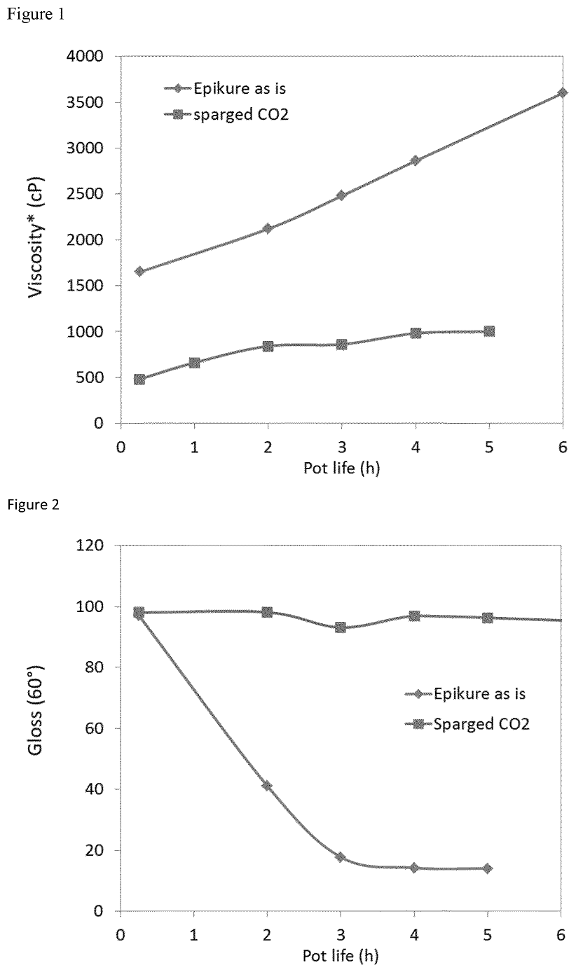

Brookfield viscosity measurement (10 rpm) of the formulations (with CO2 treatment of part B—Example 2: squares; and without CO2 treatment of part B—Example 1: diamonds) as a function of pot life are shown in FIG. 1 attached. Most striking is the much lower viscosity and lesser increase in viscosity as a function of pot life of the formula made with CO2-treated hardener compared to that made with the hardener as received. Note that for the pot life=22 h for the formula using CO2-treated hardener, the Brookfield viscosity (10 rpm) was measured to be 1900 mPa·s (not shown in graph).

Coating general visual appearance on opacity cards

For Example 1, the initial drying conditions at ambient were noted as temperature T=20.9° C., relative humidity RH=65%.

For Example 2, the initial drying conditions at ambient were noted as temperature T=21.7° C., relative humidity RH=66%.

For each Example/composition, coatings were made after different “pot lifes” i.e. after different time intervals from the mixing of the 2 components (part A & part B) and the application of the coating. The general appearance of the coatings was taken 1 week after application (curing at ambient).

For Example 1, at short pot life (t=30 min), the film appearance was excellent, resulting in a transparent film with a good, glossy visual aspect. However, after 2 hours pot life a degradation in the film's glossy appearance was observed. At 3 hours pot life the film aspect was poor, presenting cracks and opaque regions. This became even worse as the pot life increased to 4 h and above.

For Example 2, for all the films regardless of pot life, the visual appearance was excellent, resulting in a transparent film with a good, glossy visual aspect. At the longest pot life (=22 h), there was only a slight degradation in film transparency.

### Coating Gloss Measurement

Gloss measurements were made on the dry coatings which were applied on varnished opacity cards (PA2810-250) using a ÉCO 3-GLOSS 20-60-85° glossmeter (calibrated, Brant industrie), which is able to give gloss measurements at 3 different angles (20-60-85°) simultaneously.

Gloss measurements were made on the films after 3 weeks curing at ambient. The results are plotted as a function of pot life in FIG. 2 attached.

For the formula of Example 2, excellent gloss values at 60° (of 98% to typically 96%) were observed for a pot life from 0 to 5 h, values which were significantly better than those measured for the formula of Example 1 (except for very short pot life). Note for the pot life=22 h of Example 2, the gloss value (60°) was 81% (not shown on graph).

### Chemical Resistance

The coatings tested were applied on aluminum substrates with a 100 μm wet film thickness, resulting in dry film thicknesses of typically 25 μm. All films had been cured at ambient temperature for a period of approximately 6 weeks before solvent resistance tests were made. Besides, some of the dry films (already cured at ambient during 6 weeks) were placed in an oven at high temperature (either 95° C. or 120° C. depending on the test) and subjected to this cure temperature for a period of 90 minutes.

Solvent resistance was tested using the ‘double-rub’ method. According to this test procedure, a Q-tip (cotton bud) is immersed in the specific solvent to be used (e.g. ethanol, acetone, MEK). The coating is then subjected to 25 ‘double rubs’ by placing the imbibed cotton tip onto the coating and effecting a “to and from” motion for each ‘double rub’. After the 25 double rubs, the coating is inspected visually. If the coating has been damaged to the extent that the underlying substrate is exposed, the test result is considered as ‘fail’. If however the substrate is not exposed (i.e. a continuous coating remains where the rubbing was made), the test result is considered a ‘pass’. In the case of a ‘pass’ for 25 double rubs using MEK, the test was extended to find the maximum number of MEK double rubs until exposure of the substrate.

A summary of the results obtained is given in Table 3 below.

TABLE 3

| | | Solvent (no. double rubs) | | | | |
|---|---|---|---|---|---|---|
| | | | | 1M | | |
| Coating | | | | Acetic | | MEK |
| formula- | Post-cure | Ethanol | Acetone | acid | MEK | (up to |
| tion | conditions | (25) | (25) | (25) | (25) | 300) |
| Example 1 | Ambient | PASS | PASS | PASS | PASS | >100 |
| Example 2 | Ambient | PASS | FAIL | PASS | FAIL | — |
| | Ambient + | PASS | FAIL | — | — | — |
| | T = 95° C. | | | | | |
| | 90 m | | | | | |
| | Ambiant + | PASS | PASS | PASS | PASS | >200 |
| | T = 120° C. | | | | | |
| | 90 m | | | | | |

### Example 3: Chemical Resistance Vs Curing Conditions

Treatment of Hardener (Part B) with Carbon Dioxide

A mass of 50 g of Epikure hardener was measured into a beaker. The pH was measured and determined to be 10.7. The hardener was CO2 sparged via a gas dispersion tube connected to a CO2 cylinder, for a duration of 40 minutes. The pH was re-measured, and determined to be 7.2, suggesting that a significant reaction between the amines and the CO2 had taken place.

### Formulation

For the part A 200 g of ‘stock’ solution was made in advance, comprising 119.6 g EPI-REZ™ resin, 7.4 g solvent DPnB and 24 g water. The solvent (DPnB) was previously added to the resin and water and left to stir overnight, to ensure a good partitioning between the solvent and the epoxy particles comprising the resin. The weights of each material that were used in the WB epoxy coating are given in Table 4 below.

TABLE 4
Waterborne (WB) Epoxy Coating Formulation 2

| Reference | Mass (g) |
|---|---|
| Part A | |
| EPIKOTE™ Resin 6520-WH-53 | 29.9 |
| DOWANOL™ DPnB | 1.8 |
| water | 6.0 |
| Total A | 37.8 |
| Part B | |
| EPIKURE™ 6870-WH-53 - CO2 | 12.2 |
| Total B | 12.2 |
| Total A & B | 50.0 |

### Coatings at Short and Very Long Pot Life

For the pot life test, the part B was added to the part A and stirred vigorously with a spatula to assure homogenization, the whole formulation being contained in a 100 mL tricorn beaker.

Four different application conditions are tested:
1. Coatings are applied after a ‘short’ pot life (<1 hour) and left to cure under ambient conditions for 24 hours
2. Coatings are applied after a ‘short’ pot life (<1 hour) and are then immediately cured at T=95° C. for 90 minutes, after which they are left under ambient conditions for 24 hours
3. Coatings are applied after a ‘very long’ pot life of 24 hours and left to cure under ambient conditions for a further 24 hours.
4. Coatings are applied after a ‘very long’ pot life of 24 hours, after which they are then immediately cured at T=95° C. for 90 minutes and then left under ambient conditions for 24 hours

Note: for the specific case of the very long pot life (24 h), the formulations were covered with parafilm to avoid evaporation.

Solvent resistance, visual appearance & film gloss were determined using the methods previously described.

### Results

All of the coatings made under the above conditions had an excellent visual appearance, and the formulation remained sufficiently fluid to apply a coating even after 24 hours. Hence the effective pot life of this formulation made using the CO2-treated hardener is at least 24 hours.

The coatings were subjected to 25 double rubs with various solvents to test their solvent resistance. A summary of the solvent resistance results is given in Table below.

TABLE 5

| | | Solvent (no. double rubs) | | | | |
|---|---|---|---|---|---|---|
| | | | | 1M | | |
| | | | | Acetic | | MEK |
| | Cure | Ethanol | Acetone | acid | MEK | (up to |
| Coating | conditions | (25) | (25) | (25) | (25) | 300) |
| CO2-sparged | ambient | PASS | FAIL | — | — | — |
| tₚₒₜ < 1 h | T = 95° C. | PASS | PASS | PASS | PASS | >300 |
| | 90 m | | | | | |
| CO2-sparged | ambient | PASS | FAIL | — | — | — |
| tₚₒₜ = 24 h | T = 95° C. | PASS | PASS | PASS | PASS | >300 |
| | 90 m | | | | | |

### Additional Tests and Results 1

A formulation quite similar to formulations 1 and 2 detailed above was tested at ‘short’ pot life (15 minutes) with the results set forth below.
the WB epoxy formulation using the hardener as is (no CO2 sparging), was cured 15 minutes at ambient followed by a temperature cure at T=80° C. for 15 minutes, followed by 13 days at ambient; it showed very good chemical resistance: 225+/−50 double rubs with MEK
the WB epoxy using a CO2 treated hardener, was cured 15 minutes at ambient followed by a temperature cure at T=80° C. for 15 minutes, followed by 13 days ambient; it showed very good chemical resistance: 206+/−50 double rubs with MEK
the WB epoxy formulation using the hardener as is (no CO2 sparging), left simply at ambient for 13 days (no temperature cure), showed good chemical resistance: 131+/−13 double rubs with MEK Both formulations (with and without CO2 treatment of the hardener) were then kept for a further 24 hours. The WB epoxy using hardener as is (no CO2) was a gel after this time and could not be applied as a coating. The WB epoxy using CO2 treated hardener on the other hand remained fluid and applicable as a coating after 24 hours. This “aged” formulation/sample was tested with the results set forth below.
after curing for 15 minutes at ambient followed by a temperature cure at T=80° C. for 15 minutes, followed by 13 days ambient: it showed good chemical resistance: 144+/−40 double rubs with MEK
after having simply been left at ambient for 13 days: it showed very poor chemical resistance: only 18+/−2 double rubs with MEK.

### Additional Tests and Results 2

A formulation quite similar to formulations 1 and 2 detailed above was tested at ‘short’ pot life (15 minutes) with the results set forth below.
the WB epoxy formulation using the hardener as is (no CO2 sparging), was cured 15 minutes at ambient followed by a temperature cure at T=70° C. for 30 minutes, followed by 7 days at ambient; it showed good chemical resistance: 144 +/−24 double rubs with MEK
the WB epoxy using a CO2 treated hardener, was cured 15 minutes at ambient followed by a temperature cure at T=70° C. for 30 minutes, followed by 7 days ambient; it showed good chemical resistance: 131+/−31 double rubs with MEK

Both formulations (with and without CO2 treatment of the hardener) were then kept for a further 24 hours. The WB epoxy using hardener as is (no CO2) was a gel after this time and could not be applied as a coating. The WB epoxy using CO2 treated hardener on the other hand remained fluid and applicable as a coating after 24 hours. This “aged” formulation/sample was tested with the results set forth below.
after curing for 15 minutes at ambient followed by a temperature cure at T=70° C. for 30 minutes, followed by 7 days ambient: it showed good chemical resistance: 131+/−24 double rubs with MEK
after having simply been left at ambient for 7 days: it showed very poor chemical resistance: only 15+/−3 double rubs with MEK.

### Additional Tests and Results 3

A formulation similar to formulation 2 detailed above was made. However, this time the hardener was treated with CO2 and kept in a sealed flask for a period of 19 days before the waterborne epoxy formulation was made. The formulation above was tested at ‘short’ pot life (15 minutes) with the results set forth below.
the WB epoxy using a CO2 treated hardener (19 days old) was cured 15 minutes at ambient followed by a temperature cure at T=70° C. for 30 minutes, followed by 7 days ambient; it showed good chemical resistance: 113+/−14 double rubs with MEK

The formulation using a CO2 treated hardener (19 days old) was then kept for a further 24 hours. It remained fluid and applicable as a coating after 24 hours. This “aged” formulation/sample was tested with the results set forth below.
after curing for 15 minutes at ambient followed by a temperature cure at T=70° C. for 30 minutes, followed by 7 days ambient: it showed good chemical resistance: 119+/−24 double rubs with MEK
after having simply been left at ambient for 7 days: it showed very poor chemical resistance: only 15+/−3 double rubs with MEK.

### Example 4

The materials detailed in Table 6 below were used to make the waterborne epoxy coating formulation 3 detailed in Table 7 below, using a preparation method similar to the ones described above.

TABLE 6

| Reference | Material | Description |
|---|---|---|
| EPIREZ-1 | EPIKOTE™ | 53% solids. non-ionic aqueous |
| | Resin 6520- | dispersion of a modified EPON™ |
| | WH-53 | Resin 1001 type solid epoxy |
| | | resin (EEW = 550) |
| BECKOPOX- | BECKOPOX® | 55% solids. Aliphatic polyamine |
| 1 | VEH | adduct (AHEW: form of |
| | 2188w/55WA | delivery: 380 g/mol |
| | | solid matter: 215 g/mol) |
| DPnB | DOWANOL™ | Dipropylene glycol n-butyl ether. |
| | DPnB | |

TABLE 7
Waterborne (WB) Epoxy Coating Formulation 3

| Material | Mass g |
|---|---|
| PART A | |
| Epikote resin 6520-WH-53A | 35.00 |
| DPNB | 1.75 |
| H2O | 10.00 |
| TOTAL A | 46.75 |
| Material | Mass g |
| PART B | |
| Beckopox® VEH 2188w_55WA | 9.85 |
| H2O | 4.47 |
| TOTAL B | 14.32 |
| TOTAL A + B | 61.07 |

Wet films of the WB epoxy coating formulations were applied to various substrates and left to cure as follows: (a) dry/cure for 15 minutes at ambient temperature under a fume hood then (b) cure at T=80° C. in a laboratory oven for 15 minutes. After the high temperature cure, the coatings were left to rest at ambient temperature. Coating visual appearance and film gloss were assessed following the methods described in the previous examples. Gloss measurements were made on the films 4 days after application and cure. The chemical resistance of the coatings was made 9 days after application and cure. The coating's chemical resistance was determined by the maximum number of MEK double rubs until exposure of the substrate as described previously.

### Results

At pot life times of t=10 minutes to 2 hours, the film appearance is excellent, resulting in a transparent film with a good, glossy visual aspect. Also during this time period we note that the formulation remains fluid and easy to apply. At 3 hours pot life, the final visual aspect of the film is also good; however, we note that the formulation shows a marked increase in viscosity, as determined by simply stirring. After four and a half hours pot life the film quality was significantly degraded, with an extremely rough texture. In the pot, the formulation itself had become very viscous and heterogeneous (‘lumpy’). At six hours pot life the formulation had become so viscous that extra water was added to dilute it. The final film quality was very poor.

Starting from excellent gloss values (20°) of 85-86% for short pot life of 1-2 hours, the gloss starts to deteriorate (82%) at 3 h pot life, and then plummets to values <50% for longer pot life.

The MEK solvent resistance for short pot life times (0-2 h) was determined to be 100+/−16 double rubs with MEK

### Example 5

Waterborne epoxy coating formulation 4 detailed in Table 8 below was prepared using a method similar to the ones described above, except for part B which was prepared as follows:

A stock solution was made in advance comprising 5 g of hardener pre-dispersed in 5 g of water. The pH of this dispersion was determined to be 9.3. This hardener dispersion was then treated with CO2, by gently bubbling CO2 through a gas dispersion tube immersed in the sample, whilst simultaneously mixing using a magnetic stirrer. After 20 minutes of CO2 sparging, the sample pH was re-measured and found to be 7.1, indicating that a significant reaction between the CO2 and the hardener amines had occurred. We noted that the initially opaque and white dispersion had become less opaque and yellow in colour as a result of the CO2 treatment, suggesting a reduction in the dispersion particle size. The sample was then hermetically sealed with a cap and left overnight for any foam/bubbles generated by the bubbling to separate out.

TABLE 8
Waterborne Epoxy Coating Formulation 4

| Material | Mass (g) |
|---|---|
| PART A | |
| EPIKOTE™ Resin 6520-WH-53 | 14.0 |
| DPNB | 0.7 |
| H2O | 4.0 |
| TOTAL A | 18.7 |
| Material | Mass (g) |
| PART B | |
| Beckopox® VEH 2188w_55A | 4.0 |
| H2O | 4.0 |
| TOTAL B | 8.0 |
| TOTAL A + B | 26.7 |

Wet film application & cure was as described above for Example 4, and coating visual appearance and film gloss were also assessed as described above for Example 4. Additionally some coatings were made at very short pot life (0 h) and very long pot life (25 h) and left to cure at ambient over the 9 day period (no high temperature cure).

### Results

At pot life times of t=10 minutes to 5 hours, the film appearance is excellent, resulting in a transparent film with a good, glossy visual aspect. Also during this time period the formulation remains fluid and easy to apply. Even for the coating made after 25 hours pot life, the final visual aspect of the film was very good. Similarly, the formulation remains fluid, albeit somewhat more viscous than for short pot life. Also, the gloss values measured on the coating at 25 h pot life were very good (respectively 78% at 20°, 96% at 60° and 90% at) 85°.

The MEK solvent resistance for pot life of 0 to 5 h was determined to be 92+/−13 double rubs with MEK, close to the value for the reference film in example 4 at short pot life (0-2 h). For the 25 hour pot life coating the MEK solvent resistance was 160+/−70 double rubs.

Finally, for the additional coatings at very short pot life (0 h) and very long pot life (26 h) which were left to cure simply at ambient over the 9 day period (no high temperature cure), the MEK solvent resistance was very poor (<25 double rubs)

### Example 6: Chemical Resistance Testing for Lower Temperature Curing Conditions

The chemical resistance of WB epoxy coating formulation 5 given in Table 9 below was evaluated, both in a version where part B was used as such and in two versions where part B was treated by CO2 sparging:
1. The CO2-sparged part B was mixed with the part A soon after CO2 sparging (1 hour);
2. The CO2-sparged part B was covered with parafilm pierced with three small pinholes and left to stand overnight to eliminate any ‘excess’ CO2. The sample had become completely transparent, suggesting a solubilisation of the hardener dispersion.

TABLE 9
Waterborne Epoxy Coating Formulation 5

| Material | Mass (g) |
|---|---|
| PART A | |
| Epikote resin 6520-WH-53A | 14.00 |
| DPNB | 0.70 |
| H2O | 1.85 |
| TOTAL A | 16.55 |
| Material | Mass (g) |
| PART B | |
| Beckopox® VEH | 3.94 |
| 2188w_55A | |
| H2O | 3.94 |
| TOTAL B | 7.88 |
| TOTAL A + B | 24.43 |

### Wet Film Application and Cure.

Wet films of the WB epoxy coating formulations were applied to various substrates and left to cure. All the film coatings were left initially to dry/cure for 15 minutes at ambient temperature under a fume hood. The coatings were then separated into four separate groups and then subjected to cure at higher temperature in a laboratory oven under one of the following conditions:
(i) T=60° C. for 15 minutes (ii) T=60° C. for 30 minutes (iii) T=70° C. for 15 minutes (iv) T=70° C. for 30 minutes. After the high temperature cure the coatings are left to rest at ambient temperature. Some coatings were applied within 1 hour after the mixing of the part A and part B, that is well before the end of the pot life, and others were applied after more than 24 hours pot life.

### Coatings Samples for MEK Solvent Resistance Tests

The coatings tested were those applied on aluminium substrates with a 100 μm wet film thickness, resulting in dry film thicknesses of typically 25 μm. After the initial curing (ambient for 15 minutes followed by specific curing conditions at 60 or 70° C. for 15 or 30 minutes) the coatings were stored under ambient conditions for a further 7 days before solvent resistance tests were made.

### MEK Solvent Resistance Results

Solvent resistance was tested using the ‘double-rub’ method described above. Results for each curing of the curing conditions (i)-(iv) are summarized in tables 10 to 13 below

TABLE 10
MEK resistance for cure condition (i) T = 60° C. for 15 minutes

| | Average MEK | standard |
|---|---|---|
| WB Epoxy system | double rubs | deviation |
| Reference | 54 | 14 |
| CO2-treated hardener 1 | 63 | 14 |
| CO2-treated hardener 2 | 64 | 8 |
| CO2-treated hardener 1 > 24 h | 115 | 31 |

TABLE 11
MEK resistance for cure condition (ii) T = 60° C. for 30 minutes

| | Average MEK | standard |
|---|---|---|
| WB Epoxy system | double rubs | deviation |
| Reference | 60 | 7 |
| CO2-treated hardener 1 | 60 | 12 |
| CO2-treated hardener 2 | 60 | 12 |
| CO2-treated hardener 1 > 24 | 93 | 9 |

TABLE 12
MEK resistance for cure condition (i) T = 70° C. for 15 minutes

| | Average MEK | standard |
|---|---|---|
| WB Epoxy system | double rubs | deviation |
| Reference | 66 | 9 |
| CO2-treated hardener 1 | 88 | 25 |
| CO2-treated hardener 2 | 55 | 6 |
| CO2-treated hardener 1 > 24 | 93 | 27 |

TABLE 13
MEK resistance for cure condition (i) T = 70° C. for 30 minutes

| | Average MEK | standard |
|---|---|---|
| WB Epoxy system | double rubs | deviation |
| Reference | 70 | 4 |
| CO2-treated hardener 1 | 131 | 50 |
| CO2-treated hardener 2 | 64 | 8 |
| CO2-treated hardener 1 > 24h | 88 | 48 |

For the coatings made at short pot life (<1 hour) the number of MEK double rubs to reach the substrate for the coatings made using CO2-treated hardener is on average either equivalent to or greater than that of the reference systems under the same curing conditions.

The coatings made using the CO2-treated hardener with very long, extended pot life (>24 hours) also have a good solvent resistance.

Should the disclosure of any patents, patent applications, and publications which are incorporated herein by reference conflict with the description of the present application to the extent that it may render a term unclear, the present description shall take precedence.

1. A method for producing a waterborne curing agent for a waterborne epoxy coating formulation, said method comprising a step of carbonating a waterborne dispersion of a water insoluble curing agent comprising amine and/or amide functional groups.

2. The method of claim 1, wherein the water insoluble curing agent is a polyamide, a polyamidoamine or a polyamine.

3. The method of claim 2, wherein the water insoluble curing agent is a polyamine, preferably a polyamine having an amine value of 100 to 350.

4. The method of claim 3, wherein the polyamine is comprised of a modified polyamine adduct.

5. The method of claim 4, wherein the modified polyamine adduct comprises aliphatic polyamine moieties which are reacted with bisphenol A diglycidyl ether; and/or amine functions which are reacted with EO/PO and/or with fatty acids.

6. The method according to claim 1, wherein the water insoluble curing agent comprises a built-in surfactant and/or the waterborne dispersion of the water insoluble curing agent comprises a surfactant in its liquid phase.

7. The method according to claim 1, wherein the step of carbonating is conducted by contacting the dispersion of the water insoluble curing agent with liquid, solid or gaseous carbon dioxide.

8. The method of claim 7, wherein the step of carbonating is conducted at atmospheric pressure, by bubbling CO2 gas in the dispersion of the water insoluble curing agent at room temperature.

9. The method according to claim 1, wherein the step of carbonating is ended when the pH of the dispersion is stable and close to a target value.

10. A waterborne epoxy coating formulation comprising a waterborne curing agent produced according to the method of claim 1.

11. A process for providing a substrate with a waterborne epoxy coating, said process comprising the steps of:
producing a waterborne curing agent by the method of claim 1;
mixing said waterborne curing agent with a waterborne epoxy dispersion to obtain a waterborne epoxy coating formulation (the mixing step);
applying said waterborne epoxy coating formulation on a substrate (the application step);
curing the waterborne epoxy coating formulation on the substrate (the curing step).

12. The process of claim 11, wherein a solvent is introduced in the waterborne epoxy coating formulation as a separate ingredient during the mixing step and/or via the waterborne curing agent and/or via the waterborne epoxy dispersion.

13. The process of claim 12, wherein the solvent is chosen among acetone and glycol ethers.

14. The process according to claim 11, wherein the waterborne curing agent is made substantially free of CO2 gas bubbles prior to its use in the mixing step.

15. The process according to claim 11, wherein the curing step is performed at a temperature between 5° and 90° C.

16. The process of claim 4, wherein the polyamine is comprised of a modified polyamine adduct comprising primary and/or secondary unhindered amine groups.

17. The process of claim 16, wherein the primary and/or secondary unhindered amine groups are triethylenetetramine or N,N′-bis(3-aminopropyl)ethylenediamine moieties.
